(19) United States
(12) Patent Application Publication
(10) Pub. No.: US 2007/0100710 A1
(43) Pub. Date: May 3, 2007

(54) System and methods for m-commerce transactions

(76) Inventor: Moneet Singh, Conshohocken, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/590,965

(22) Filed: Oct. 31, 2006

Related U.S. Application Data
(60) Provisional application No. 60/732,029, filed on Nov. 1, 2005.

(51) Int. Cl. G06Q 30/00

(52) U.S. Cl. 705/26

(57) ABSTRACT

System and methods are provided to allow for a secondary confirmation when engaging in mobile commerce transactions. In an illustrative implementation, the herein described system and methods allow parties engaged in m-commerce transactions to perform multiple transactions simultaneously over a plurality of phone numbers or short codes assigned to each party by a “Reply-to Number” engine. Assigning each party a unique phone number or short code to which each shall deliver his/her replies allows the m-commerce system implementing the herein described system and methods to provide simpler user interaction with the system, reduces the incidence of user error, and also allows the m-commerce system to better track the transactions being performed to reduce the incidence of error in the transactions.

### CLAIM OF PRIORITY AND CROSS REFERENCE

This non-provisional patent application claims the benefit of the filing date of the following provisional application, which is herein incorporated by reference: provisional application No. 60/732,029, filed Nov. 1, 2005, entitled “Method for Conducting Transactions Securely and/or Anonymously over a Wireless Communications Network Using Phone Numbers and/or Short Codes.”

### BACKGROUND

The availability of cellular phones enabled with the ability to send and receive messages using the Short Message Service (SMS), or “text messages,” and the Multimedia Message Service (MMS) gives businesses, merchants and users the ability to provide mobile commerce functionality based upon SMS and MMS communications. Such mobile commerce, or “m-commerce” services may be marketed by associating the service with a designated phone number or a cellular “short code,” a numeric string of four to eight numbers in length which functions akin to a domain name on the Internet. The mobile phone user may use the designated phone number or short code to send messages via SMS or MMS to request that a transaction take place involving the merchant or one or more other parties. These services, branded with the designated phone number or short code, may allow a business/merchant to build “brand equity” in the phone number or short code, akin to a business/merchant building brand equity in an “800” phone number or an Internet domain name.

Security issues may arise in such an SMS or MMS based m-commerce system if the transactions are conducted solely against a fixed, known phone number or short code. If a single phone number or short code is used, and were a malicious hacker able to “listen in” to the phone number or short code, the malicious hacker would be able to access all of the SMS or MMS messages used in the compromised transactions and could “piece together” the messages to determine which user PIN codes correspond to which user phone numbers. As the malicious hacker could then engage in identity theft or fraud against the merchant, this security issue is problematic for both the users of the m-commerce system and the merchant providing or using the system.

Operational issues may also arise if an m-commerce system based upon SMS or MMS messages implements a single phone number or short code. In an m-commerce system based upon a single phone number or short code, the user may be limited in the number of “open” transactions in which he may engage. In such an m-commerce system, the user may be required to enter additional information in each SMS or MMS message to specify to the merchant which specific transaction the message applies to. Without such additional input from the user, the m-commerce system will not be able to differentiate the user's transactions. Given the limited user interface of SMS or MMS messages (e.g., SMS messages in the United States may not exceed one hundred sixty characters), the requirement to submit additional information to the merchant may make the user's transaction experience feel user-unfriendly.

From the foregoing it is appreciated that there exists a need for a system and methods to ameliorate the shortcomings of existing practices.

### SUMMARY

System and methods are provided to allow for a secondary confirmation when engaging in mobile commerce transactions. In an illustrative implementation, the herein described system and methods allow parties engaged in m-commerce transactions to perform multiple transactions simultaneously over a plurality of phone numbers or short codes assigned to each party by a “Reply-to Number” engine. Assigning each party a unique phone number or short code to which each shall deliver his/her replies allows the m-commerce system implementing the herein described system and methods to provide simpler user interaction with the system, reduces the incidence of user error, and also allows the m-commerce system to better track the transactions being performed to reduce the incidence of error in the transactions.

In an illustrative implementation, an exemplary mobile commerce transaction system comprises a “Reply-to Number” engine and a computing environment operated by the merchant offering or facilitating the mobile commerce transactions. Users of the m-commerce system implementing the herein described system and methods will generally interact with it using text messages delivered via the Short Message Service (SMS) or the Multimedia Messaging Service (MMS). SMS or MMS messages from the m-commerce system will be delivered to the users over the plurality of phone numbers or short codes assigned to each party. Upon the completion of the transactions, the “Reply-to Number” engine releases the phone numbers or short codes to a pool of available phone numbers or short codes leased or maintained by the merchant for use in further transactions.

Other features of the herein described system and methods are described further below.

### BRIEF DESCRIPTION OF THE DRAWINGS

Referring now to the drawings, in which like reference numbers refer to like elements throughout the various figures that comprise the drawing. Included in the drawings are the following figures:

FIG. 1 illustrates an exemplary “Reply-to Number” environment depicting the components comprising the invention in accordance with the herein described systems and methods;

FIG. 2 illustrates a security process undertaken by an illustrative implementation of the herein described system and methods;

FIG. 3 depicts a flow chart diagram of an illustrative implementation using a “branded” short code performing in accordance with the herein described systems and methods.

### DETAILED DESCRIPTION OF THE ILLUSTRATIVE IMPLEMENTATIONS

Overview

Merchants and business entities providing or facilitating mobile commerce transactions may use the method and system described herein to better protect their users from malicious entities attempting to “listen in” to the messages used in the m-commerce transaction. For sessionless communications technologies such as SMS and MMS, the herein described system and methods allow an m-commerce service and its users to participate in distinct, identifiable transactions with a simpler user interface and higher security.

The herein described system and methods can be embodied in an information technology system, such as an electronic system used for mobile commerce transactions using cellular or other electronic communications. A person skilled in the arts of computer programming, information technology system architectures, information technology system design and electronic communications technologies may adapt the herein described system and methods to various information technology systems regardless of their scale.

The herein described system and methods allows for a given transaction to take place using different phone numbers or short codes, such as an m-commerce transaction initiated on a “branded” short code (such as a short code whose numeric string corresponds to a word of equal character length, e.g., the short code “28948” would correspond to “BuyIt”) and completed using different short codes drawn from the pool of available phone numbers or short codes. Therefore, monitoring only the branded short code will be insufficient for a malicious party to obtain the transmitted information related to the transaction and to use the information to commit fraud against an m-commerce system implementing the invention. Furthermore, the parties to the m-commerce transaction will not know the phone numbers or short codes issued to the other parties during the transaction, helping increase the privacy of the transaction and allowing for higher anonymity of the parties to the transaction. This aspect of the herein described system and methods can reduce “brute force” attacks against the m-commerce system, which necessitate that one party be aware of a shared piece of information (e.g., if all parties used the same phone number or short code, the one party could use that as a known text to decrypt transmissions).

Exemplary “Reply to Number” Environment

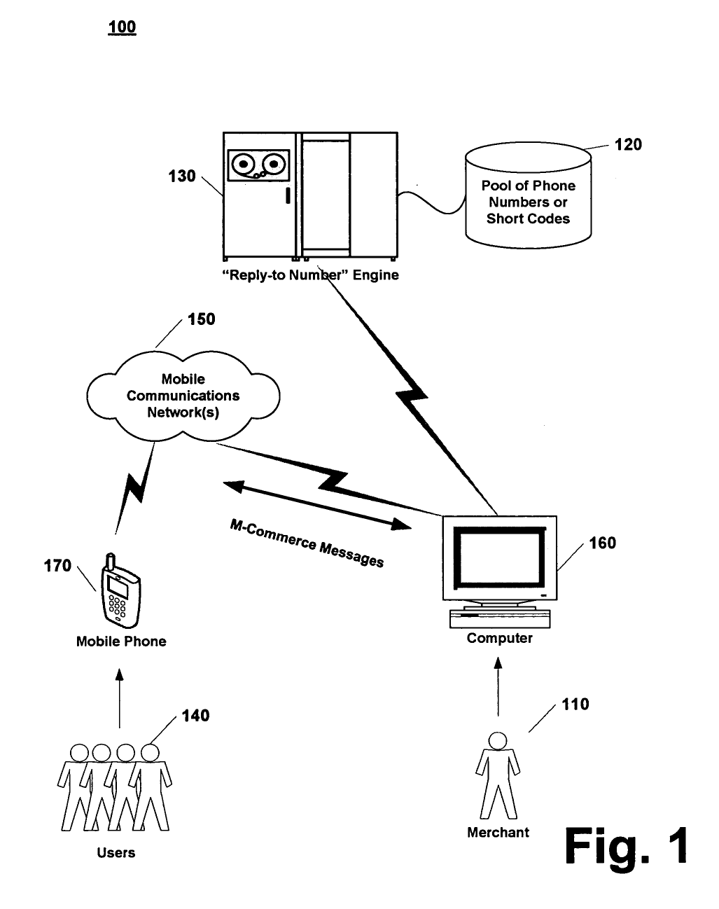

FIG. 1 illustrates the exemplary “Reply-to Number” environment 100, which comprises a merchant 110, a “pool” 120 of available phone numbers or short codes leased by the merchant, a “Reply-to Number” engine 130 which interacts with the pool of available phone numbers or short codes, users 140 of the merchant's m-commerce service, the mobile communications network 150, a merchant computing environment 160, and mobile communications devices 170, such as cellular phones, with which the users communicate with the merchant computing environment using m-commerce messages, delivered in one embodiment of the invention as SMS messages or MMS messages.

In an illustrative operation, users 140 can engage in m-commerce with a merchant 110 (or with other users 140 as facilitated by a merchant 110) using mobile communications devices 170 and a merchant computing environment 160 operatively coupled using a mobile communications network 150. In the illustrative operation, as part of an m-commerce transaction, a user 140 will, using a mobile communications device 170, enter into a mobile commerce transaction with (or facilitated by) a merchant 110 using a merchant computing environment 160 and a “Reply-to Number” engine 130. Upon receiving an m-commerce initiating message from a user's 140 mobile communications device 170, the “Reply-to Number” engine 130 shall assign a phone number or short code randomly selected from the pool of numbers or short codes 120 to the user initiating the m-commerce transaction. The merchant computing environment 160 will complete the m-commerce transaction using this selected phone number or short code and then return the phone number or short code to the pool of phone numbers or short codes 120 when the transaction is complete.

It is appreciated that although the exemplary “Reply-to Number” 100 is described to employ specific components having a particular configuration that such description is merely illustrative as the inventive concepts described herein can be performed by various components in various configurations. For example, although a merchant provider computing environment 160 and “Reply-to Number” engine 130 are described to be separate in FIG. 1, such description is merely illustrative as these two computing environments can exist in a single computing environment.

Illustrative Process when Using the Herein Described System and Methods

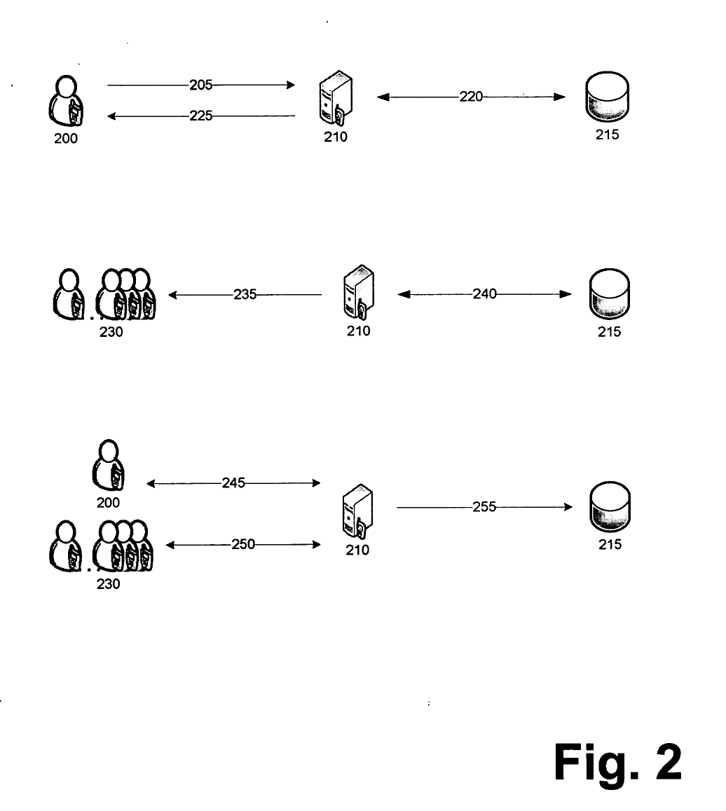

It is appreciated that the exemplary “Reply-to Number” environment 100 of FIG. 1 can maintain various operations and features. FIG. 2 provides an illustrative embodiment of exemplary processing by the exemplary “Reply-to Number” environment 100.

As is shown in FIG. 2, the illustrative process begins when a customer 200 equipped with a mobile communications device sends an m-commerce initiating message to a known phone number or short code 205 leased or maintained by a merchant. The phone number or short code leased or maintained by the merchant will be widely known to the general population and likely is a part of the marketing and branding strategy of the merchant.

The m-commerce initiating message 205 will be delivered to the merchant's information technology system 210 by the cellular communications network. The merchant's information technology system 210 as depicted in FIG. 2 will comprise a merchant provider computing environment 160 and “Reply-to Number” engine 130. The m-commerce initiating message may take the form of an SMS message, or “text message,” or an MMS message.

In the illustrative implementation, the merchant facilitates m-commerce transactions between the customer 200 and another party (or parties), such as a recipient 230. The customer's m-commerce initiating message(s) 205 include a request that the transaction take place between the customer 200 and any number [1−n] of recipients 230 as supported by the merchant's information technology system 210. The m-commerce initiating messages 205 may take such a form as “Ship 100 widgets to Recipient 1,” “Ship 50 widgets to Recipient ‘n’” or “Pay $100 to Recipient 2.” The m-commerce initiating messages 205 may be made using SMS, MMS or another session-less technology supported on a mobile communications network.

After receiving an m-commerce initiating message 205, a merchant's information technology system 210 randomly selects 220 a phone number or short code from the pool of available phone numbers or short codes 215 which have been secured by or leased by the merchant. The merchant's information technology system 210 delivers to the customer 200 a reply message via SMS or MMS over the phone number or short code 225 selected from the pool of available phone numbers or short codes 215.

The merchant's information technology system 210 then randomly selects 240 a plurality of phone numbers or short codes from the pool of available phone numbers or short codes 215 equal to the number [1−n] of recipients 230 involved in the m-commerce transaction. The merchant's information technology system 210 assigns one of each of the selected phone numbers or short codes to each of the recipients 230 involved in the m-commerce transaction. The merchant's information technology system 210 then delivers to the any number [1−n] of recipients 230 involved in the m-commerce transaction electronic SMS or MMS messages over the selected phone numbers or short codes 235.

In an embodiment of the herein described system and methods, each party to the m-commerce transaction is assigned a different phone number or short code from the pool of available phone numbers or short codes 215 so that, for any given m-commerce transaction, no party shares the same phone number or short code. Furthermore, the phone number or short code assigned to a given party to the m-commerce transaction is “checked out” from the pool of available phone numbers or short codes 215 and reserved for that specific party to the m-commerce transaction so that the phone number or short code cannot be used in any other m-commerce transaction that may be occurring simultaneously for that party.

The parties to the m-commerce transaction 200, 230 then conduct the m-commerce transaction by sending electronic SMS or MMS messages using the phone number or short code 245, 250 assigned to them by the merchant's information technology system 210. Using the example m-commerce initiating messages described above, “Recipient 1” 230 may send a SMS or MMS message using the phone number or short code assigned to him indicating his acceptance of one hundred widgets 250, after which the customer 200 receives a SMS or MMS message indicating the acceptance 245 of the one hundred widgets by “Recipient 1” 230. The customer 200 may also be prompted by a SMS or MMS message 245 to deliver a password to the merchant's information technology system 210 to authorize the transaction. The customer 200 will remit this password in a SMS or MMS message using the phone number or short code assigned to him 245. Likewise, “Recipient 2” 230 may send a SMS or MMS message using the phone number or short code assigned to him indicating his acceptance of the one hundred dollars remitted to him by the customer 200 and “Recipient ‘n’” 230 may send a SMS or MMS message using the phone number or short code assigned to him indicating his acceptance of the fifty widgets remitted to him by the customer 200.

Once the transactions are complete, the merchant's information technology system 210 releases the phone numbers or short codes 255 back to the pool of phone numbers or short codes 215 for use by the parties to other transactions. In an embodiment of the herein described system and methods, the merchant's information technology system 210 may set a time limit for use of each assigned phone number or short code during which each customer 200 or recipient 230 involved in a transaction must deliver their responses 245, 250. Failure to deliver the responses 245, 250 during the allotted time limit will cause the merchant's information technology system 210 to cancel the transaction and return 255 the assigned phone numbers or short codes to the pool of phone numbers or short codes 215. This time limit may be used to add an additional layer of security to the transaction.

Illustrative Flow Chart

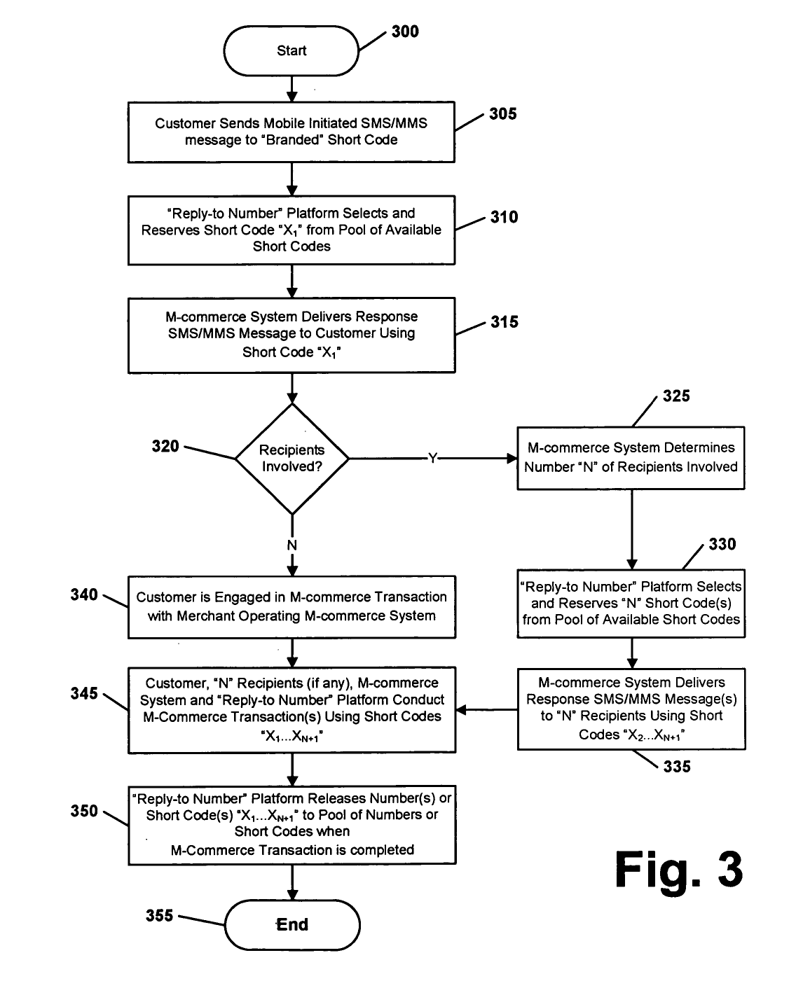

FIG. 3 presents an embodiment of the herein described system and methods using a branded short code as the number to which a customer sends an m-commerce initiating message using SMS or MMS.

At the start 300 of the process, a customer has decided to enter into an m-commerce transaction either with or facilitated by a merchant who has secured a branded short code. The customer sends an m-commerce initiating message via SMS or MMS to the branded short code 305 to begin the transaction. The m-commerce initiating message is received by the merchant's information technology system, or m-commerce system, which then instructs the “Reply-to Number” platform to select and reserve a short code, labeled as “X₁,” from the pool of available short codes 310. The m-commerce system will remit a SMS or MMS reply to the customer using the selected short code “X₁” 315 indicating that the transaction shall proceed; in one embodiment, the SMS or MMS reply sent to the customer using the selected short code “X₁” may ask the customer to remit his PIN to the m-commerce system via an SMS or MMS message sent to the selected short code “X₁.”

The m-commerce system will determine if, in the transaction at hand, the merchant is facilitating an m-commerce transaction between the customer and one or more third-party recipients or an m-commerce transaction between the merchant itself and the customer 320. If the transaction does involve one or more recipients, the m-commerce system will first determine the number “N” of recipients involved 325. The “Reply-to Number” platform will then randomly select and reserve a total of “N” short codes from the pool of available short codes 330, thereupon assigning each randomly selected short code to a recipient. If the m-commerce system determines that the customer is attempting to engage in an m-commerce transaction with the merchant only 340, it will omit this step and move to the step in which the m-commerce transaction is performed 345.

The m-commerce system then delivers a response SMS message to each of the “N” recipients involved in the transaction 335 using the selected short codes, identified as short codes “X₂−X_{N+1}.” The total number of short codes selected from the pool will be “N+1” (one for the customer and “N” for the recipients). The m-commerce system and “Reply-to Number” platform then facilitate the m-commerce transactions over the selected short codes 345, after which the short codes are released to the pool 350 when the m-commerce transactions are complete.

If the herein described system and methods were not utilized in an m-commerce system based upon SMS or MMS messages, a user would need to include a text string in each SMS/MMS message to indicate to the m-commerce system which transaction the user was referring to. A comparison between the message flow of an m-commerce system utilizing the invention and one without using the invention may illustrate difference in the user interface.

The first illustrative process is of an m-commerce system which does not implement the herein described system and methods. First, a customer would send an m-commerce initiating SMS message to a branded short code with an m-commerce request, such as “Ship 100 widgets to Recipient 1.” As the m-commerce system would need to reply to the customer using the same short code, it would have to include a text string identifier which the customer would be prompted to include in all subsequent SMS messages so that the m-commerce system could differentiate the “Ship 100 to Recipient 1” transaction from any other m-commerce transactions the customer may initiate. Furthermore, the m-commerce system would also be required to remit the text string identifier to “Recipient 1” so that the m-commerce system could differentiate the “Ship 100 to Recipient 1” transaction from any other m-commerce transactions in which “Recipient 1” may be involved. Failure to include the transaction identifier could cause the m-commerce system to fail to properly identify which transaction either the customer or “Recipient 1” is replying to.

Assuming the branded short code is “12345,” the process would appear as follows:

1) Customer sends SMS message to short code 12345: “Ship 100 widgets to Recipient 1”

2) M-commerce system sends an SMS message to customer using short code 12345: “Confirm shipment of 100 widgets to Recipient 1 with your password and the text string ABCDE,” in which “ABCDE” is the text string identifier for the transaction

3) Customer sends SMS message to short code 12345: “password ABCDE”

4) M-commerce system sends an SMS message to Recipient 1 using short code 12345: “To receive 100 widgets from Customer, respond to this message with a ‘yes’ or ‘no’ and the text string ABCDE”

5) Recipient 1 sends an SMS message to the short code 12345: “yes ABCDE”

6) M-commerce system sends an SMS message to customer using short code 12345: “Confirmed shipment of 100 widgets to Recipient 1”

7) M-commerce system sends an SMS message to Recipient 1 using short code 12345: “Confirmed shipment of 100 units from Customer”

Were the m-commerce system to implement the herein described system and methods, the customer and “Recipient 1” would not need to enter the text string identifier “ABCDE” in the SMS messages. As this requirement is removed, so too is another source of “user error” in the m-commerce system as some users may fail to include the text string identifier, mistype the identifier or confuse which identifiers correspond to which open transactions. Thus, the herein described system and methods greatly simplify the user interface and reduces the reliance upon the user in an m-commerce setting. The herein described system and methods also takes advantage of the “asynchronous” nature of SMS/MMS messages in that it allows several transactions to be “open” (or waiting the recipient's acknowledgement or participation) while allowing the customer or m-commerce transaction initiator to engage in other m-commerce transactions prior to the completion of the open transactions.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the herein described system and methods may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for performing m-commerce transactions comprising:
an reply-to-number/short-code engine; and
an instruction set operable to provide at least one instruction to the reply-to-number/short-code engine to process electronic data according to a selected m-commerce secure transaction paradigm,
wherein the m-commerce secure transaction paradigm comprises the selection of one or more random telephone number and/or short-codes for use to perform an m-commerce transaction.

2. The system as recited in claim 1 wherein the reply-to-number/short code engine comprises a computing environment.

3. The system as recited in claim 2 wherein the instruction set comprises a computing application operable on a computing environment.

4. The system as recited in claim 3 further comprising a data store cooperating with the reply-to-number/short-code engine to retrieve and/or store selected one or more randomized mobile telephone numbers and/or short-codes.

5. The system as recited in claim 4 further comprising a communications network.

6. The system as recited in claim 5 wherein the communications network comprises a fixed wire network, a wireless network, a mobile network, and the Internet.

7. The system as recited in claim 1 wherein the instruction set direct participating users to input to the reply-to-number/short-code engine data representative of the parties of an m-commerce transaction.

8. The system as recited in claim 1 wherein the selected random one or more reply-to-number/short-codes comprises text and graphics.

9. The system as recited in claim 1 wherein the reply-to-number/short-codes engine cooperated with a mobile telephony network when operating to perform m-commerce transactions.

10. The system as recited in claim 1 wherein the reply-to-number/short-codes engine is operated by a services provider cooperating with an m-commerce merchant.

11. A method for performing m-commerce transactions comprising:
receiving data representative of a first party initiating an m-commerce transaction;
receiving data representative of other parties to the m-commerce transaction; and
selecting one or more random reply-to-numbers and/or short codes for use by the parties of the m-commerce transaction to perform the m-commerce transaction.

12. The method as recited in claim 11 further comprising communicating the selected random one or more reply-to-numbers and/or short-codes to the parties of the m-commerce transaction.

13. The method as recited in claim 12 further comprising processing the communicated selected random one or more reply-to-numbers and/or short-codes as part of an m-commerce transaction.

14. The method as recited in claim 13 further comprising releasing the selected random one or more reply-to-numbers and/or short-codes upon completing the m-commerce transaction for use in a subsequent m-commerce transaction.

15. A computer readable medium having computer readable instructions to instruct a computer to perform an m-commerce method comprising:
receiving data representative of a first party initiating an m-commerce transaction;
receiving data representative of other parties to the m-commerce transaction; and
selecting one or more random reply-to-numbers and/or short codes for use by the parties of the m-commerce transaction to perform the m-commerce transaction.

16. A method for performing m-commerce transactions comprising:
providing data representative of an m-commerce transaction; and
receiving data representative of a selected one or more random reply-to-numbers and/or short codes for use by the parties of the m-commerce transaction to perform the m-commerce transaction.

17. The method as recited in claim 16 further comprising communicating the selected random one or more reply-to-numbers and/or short-codes to the parties of the m-commerce transaction.

18. The method as recited in claim 17 further comprising processing the communicated selected random one or more reply-to-numbers and/or short-codes as part of an m-commerce transaction.

19. The method as recited in claim 18 further comprising releasing the selected random one or more reply-to-numbers and/or short-codes upon completing the m-commerce transaction for use in a subsequent m-commerce transaction.

20. A computer readable medium having computer readable instructions to instruct a computer to perform an m-commerce method comprising:
providing data representative of an m-commerce transaction; and
receiving data representative of a selected one or more random reply-to-numbers and/or short codes for use by the parties of the m-commerce transaction to perform the m-commerce transaction.
